(19) United States
(12) Patent Application Publication
(10) Pub. No.: US 2025/0274004 A1
(43) Pub. Date: Aug. 28, 2025

(54) ROTOR STRUCTURE

(71) Applicant: DELTA ELECTRONICS, INC., Taoyuan City (TW)

(72) Inventors: Hsiang-Chun CHEN, Taoyuan City (TW); Ming-Han LIN, Taoyuan City (TW); Yuan-Hung CHO, Taoyuan City (TW)

(21) Appl. No.: 19/001,395

(22) Filed: Dec. 24, 2024

Related U.S. Application Data
(60) Provisional application No. 63/558,280, filed on Feb. 27, 2024.

(30) Foreign Application Priority Data
Oct. 15, 2024 (CN) 202422493564.5

(51) Int. Cl. H02K 1/276

(52) U.S. Cl. CPC H02K 1/276

(57) ABSTRACT

A rotor structure includes a silicon steel main body with a plurality sets of magnetic poles, an axis and an outer edge. Each magnetic pole has a double-layer V-shaped magnet slot structures including an inner V-shaped magnet slot set near the axis and an outer V-shaped magnet slot set near the outer edge. The inner V-shaped magnet slot set has an inner magnetic bridge, and the outer V-shaped magnet slot set has an outer magnetic bridge. The width of the inner magnetic bridge is greater than the width of the outer magnetic bridge. Each magnet slot has two long edges. One of the two long edges that is relatively far away from the corresponding inner magnetic bridge or outer magnetic bridge has a blocking point. The inner V-shaped magnet slot set or the outer V-shaped magnet slot set has a pair of radial magnetic bridges.

### CROSS-REFERENCE TO RELATED APPLICATION

This application claims priority to U.S. Provisional Application Ser. No. 63/558,280, filed Feb. 27, 2024 and China Application Serial Number 202422493564.5, filed Oct. 15, 2024, the disclosures of which are incorporated herein by reference in their entireties.

### BACKGROUND

### Field of Disclosure

The magnets contained in the silicon steel main body of a motor rotor structure have tolerances and lead angles due to manufacturing dimensions. When the magnet slots in the silicon steel main body have no blocking points, there will be a displacement space for the magnets when the rotor is operating.

In addition, when the position of the magnet blocking point in the silicon steel sheet magnet slot is not proper (e.g., the magnet slot is not provided with a blocking point on the long edge where the inner/outer magnetic bridge is connected), the stress during operation is likely to be concentrated on the silicon steel bridge and causing breakage.

### SUMMARY

The present disclosure provides an improved rotor structure to deal with the needs of the prior art problems.

In one or more embodiments, a rotor structure including: a silicon steel main body has a plurality sets of magnetic poles, an axis and an outer edge, each set of magnetic pole has a double-layer V-shaped magnet slot structure; wherein the double-layer V-shaped magnet slot structure includes an inner V-shaped magnet slot group near the axis and an outer V-shaped magnet slot group near the outer edge, the inner V-shaped magnet slot group has a first included angle between a pair of inner magnet slots, the outer V-shaped magnet slot group has a second included angle between a pair of outer magnet slots, the first included angle is smaller than the second included angle; wherein the inner V-shaped magnet slot group has an inner magnetic bridge close to the axis along a radial direction, and the outer V-shaped magnet slot group has an outer magnetic bridge close to the axis along the radial direction, a width of the inner magnetic bridge is greater than a width of the outer magnetic bridge; wherein any pair of the pair of inner magnet slots and the pair of outer magnet slots has two long edges, and the one of the two long edges that is relatively far away from the corresponding inner magnetic bridge or the corresponding outer magnetic bridge has a blocking point; wherein the silicon steel main body has a rivet point, and a connection line between a mass center of the rivet point and the axis passes through the inner magnetic bridge and the outer magnetic bridge; and wherein the inner V-shaped magnet slot group or the outer V-shaped magnet slot group has a pair of radial magnetic bridges extending from the pair of inner magnet slots or the pair of outer magnet slots respectively, and the pair of radial magnetic bridges are farther from the axis than the inner magnetic bridge or the outer magnetic bridge.

In one or more embodiments, a rotor structure including: a silicon steel main body has a plurality sets of magnetic poles, an axis and an outer edge, each set of magnetic pole has a double-layer V-shaped magnet slot structure; wherein the double-layer V-shaped magnet slot structure includes an inner V-shaped magnet slot group near the axis has a pair of inner magnet slots and an outer V-shaped magnet slot group near the outer edge has a pair of outer magnet slots; wherein the inner V-shaped magnet slot group has an inner magnetic bridge close to the axis along a radial direction, and the outer V-shaped magnet slot group has an outer magnetic bridge close to the axis along the radial direction, a width of the inner magnetic bridge is greater than a width of the outer magnetic bridge; wherein any pair of the pair of inner magnet slots and the pair of outer magnet slots has two long edges, and the one of the two long edges that is relatively far away from the corresponding inner magnetic bridge or the corresponding outer magnetic bridge has a blocking point; and wherein the inner V-shaped magnet slot group or the outer V-shaped magnet slot group has a pair of radial magnetic bridges extending from the pair of inner magnet slots or the pair of outer magnet slots respectively, and the pair of radial magnetic bridges are farther from the axis than the inner magnetic bridge or the outer magnetic bridge.

In sum, the rotor structure disclosed herein optimizes the designs of the magnetic bridge and adjusts the magnetic bridge in radial extension. The radial magnetic bridge is designed in the same direction as the centrifugal force of the rotor structure's rotating state, which can reduce stress, increase the maximum rotational speed, and effectively reduce the problem of magnetic flux leakage. In addition, a magnetic barrier structure can also be added to the outer edge of the rotor structure to increase the magnetic resistance of the silicon steel sheet path and reduce the performance degradation caused by magnetic flux leakage.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 illustrates a top view of a single magnetic pole of a motor structure according to a first embodiment of the present disclosure;

FIG. 2 illustrates a top view of a single magnetic pole of a rotor structure according to a second embodiment of the present disclosure;

FIG. 3 illustrates a top view of a single magnetic pole of a rotor structure according to a third embodiment of the present disclosure;

FIG. 4 illustrates a top view of a single magnetic pole of a rotor structure according to a fourth embodiment of the present disclosure;

FIG. 5 illustrates a top view of a single magnetic pole of a rotor structure according to a fifth embodiment of the present disclosure;

FIG. 6 illustrates a top view of a single magnetic pole of a rotor structure according to a sixth embodiment of the present disclosure; and

FIG. 7 illustrates a perspective view of the single magnetic pole of the rotor structure in FIG. 6.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

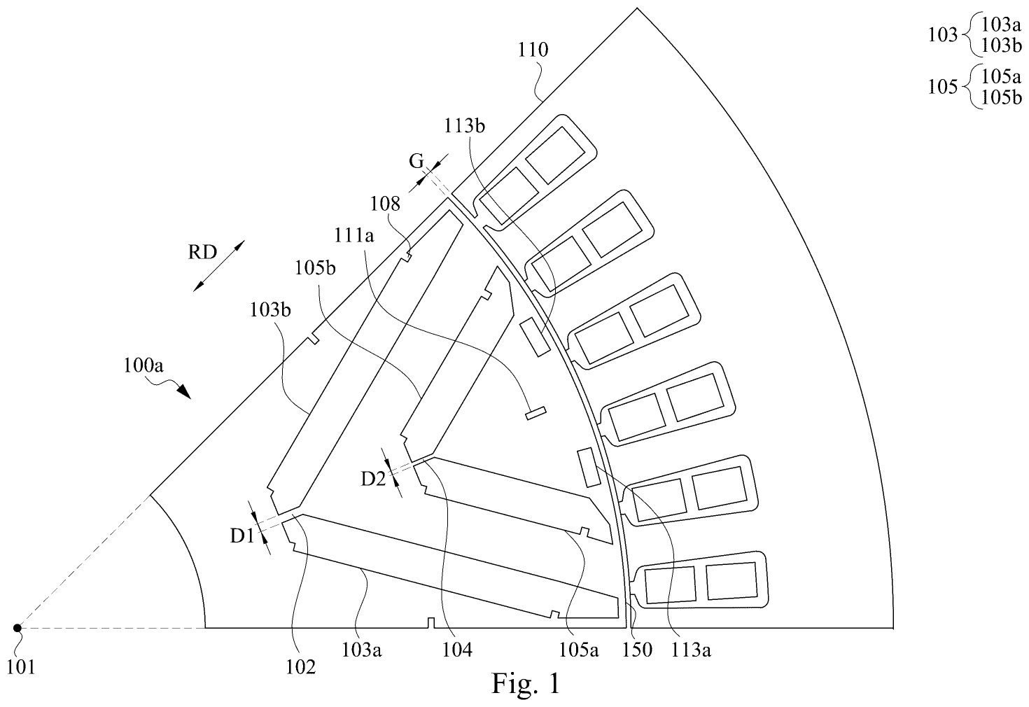

Reference is made to FIG. 1, which illustrates a top view of a single magnetic pole 100a of a motor structure according to a first embodiment of the present disclosure. The single magnetic pole 100a of the rotor structure has an inner V-shaped magnet slot group 103 near an axis 101 and an outer V-shaped magnet slot group 105 near an outer edge 150 to form a double-layer V-shaped magnet slot structure from inside to outside. There is an air gap width G between the magnetic pole 100a of the rotor structure and the stator structure 110. The inner V-shaped magnet slot group 103 includes magnet slot 103a and magnet slot 103b, and there is an inner magnetic bridge 102 between the magnet slot 103a and the magnet slot 103b along a radial direction RD and close to the axis 101. The outer V-shaped magnet slot group 105 includes magnet slot 105a and magnet slot 105b, and there is an outer magnetic bridge 104 between the magnet slot 105a and the magnet slot 105b along the radial direction RD and close to the axis 101. The width D1 of the inner magnetic bridge 102 is greater than the width D2 of the outer magnetic bridge 104. In some embodiments of the present disclosure, the magnetic pole 100a has a long rectangular magnetic barrier structure (113a, 113b) close to where between the outer V-shaped magnet slot group 105 and the outer edge 150. A long axis direction of the magnetic barrier structure (113a, 113b) is perpendicular to the outer V-shaped magnet slot group 105, and can contain air layers, magnets or high magnetic resistance materials. The magnetic pole 100a has a rivet point 111a penetrating the silicon steel main body along the axial direction, and a connection line between a geometric center of the rivet point 111a and the axis 101 passes through the inner magnetic bridge 102 and the outer magnetic bridge 104.

In some embodiments of the present disclosure, the width D2 of the outer magnetic bridge 104 is equal to the air gap width G between the rotor structure and the stator structure, where the stator structure sleeves the outer edge 150 of the rotor structure along the radial direction RD. In some embodiments of the present disclosure, the width D1 of the inner magnetic bridge 102 is 1.5 times the air gap width G between the rotor structure and the stator structure. In some embodiments of the present disclosure, a ratio of the width D1 to the width D2 ranges from 1.2 to 1.6. In some embodiments of the present disclosure, the ratio of width D1 to width D2 is equal to 1.5. Rotor structures that comply with the above width relationship have the effect of reducing magnetic bridge stress.

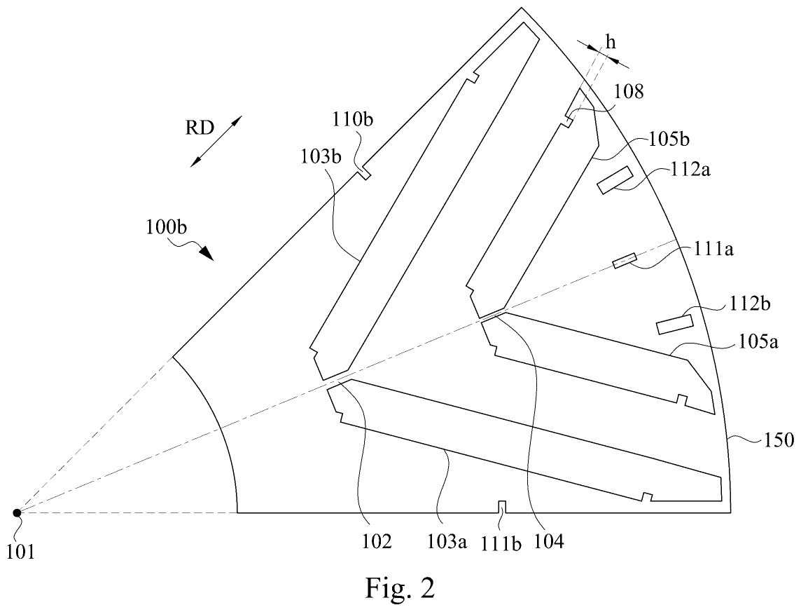

Reference is made to FIG. 2, which illustrates a top view of a single magnetic pole 100b of a rotor structure according to a second embodiment of the present disclosure. The single magnetic pole 100b of the rotor structure also has an inner V-shaped magnet slot group 103 near the axis 101 and an outer V-shaped magnet slot group 105 near the outer edge 150 to form a double-layer V-shaped magnet slot structure. The magnetic pole 100b also has an inner magnetic bridge 102 and an outer magnetic bridge 104 as well as the above technical features described in previous paragraphs. In some embodiments of the present disclosure, the magnetic pole 100b has a rivet point 111a along the axial direction, and a connection between the geometric center of the rivet point 111a and the axis 101 passes through the inner magnetic bridge 102 and the outer magnetic bridge 104. The rivet point 111a is farther away from the axis 101 or closer to the outer edge 150 than the inner magnetic bridge 102 and the outer magnetic bridge 104. In some embodiments of the present disclosure, the rivet point 111a is a rectangle, and a long axis direction of the rivet point 111a is parallel to the radial direction RD. In some embodiments of the present disclosure, the magnetic pole 100b further has at least one rivet point 111b between the magnetic poles extending along a normal vector of the magnet surface to reduce the influence on the magnetic force.

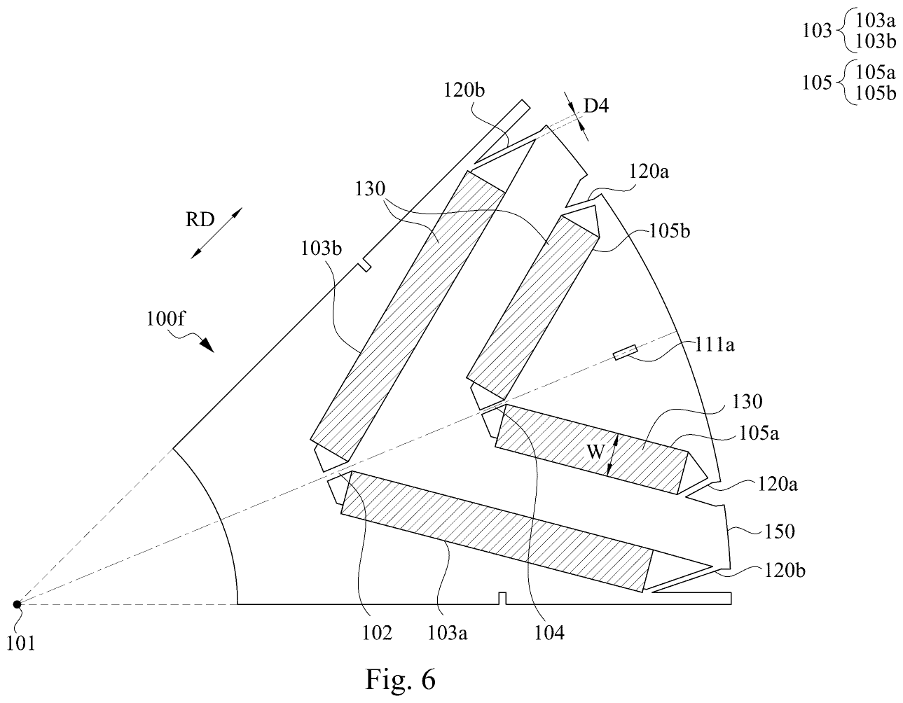

In some embodiments of the present disclosure, the magnet slot 103a, the magnet slot 103b, the magnet slot 105a and the magnet slot 105b all have blocking points 108. The blocking points 108 are located on the one of the two long edges of each magnet slot that is relatively far away from the corresponding inner magnetic bridge 102 or the corresponding outer magnetic bridge 104. In some embodiments of the present disclosure, the magnet 130 accommodated in the magnet slot has a width W (for example, refer to FIG. 6), the blocking point 108 has a height h, and a relationship between the height h of the blocking point 108 and the width W of the magnet 130 is W/10≤h≤W/5. This relationship also applies to the height of the blocking point 108 in other embodiments of the present disclosure. In some embodiments of the present disclosure, the magnetic pole 100b is different from other embodiments in that it has a long rectangular magnetic barrier structure (112a, 112b) close to and between the outer V-shaped magnet slot group 105 and the outer edge 150. The long axis direction of the magnetic barrier structure (112a, 112b) is perpendicular to the outer edge 150 or the outer V-shaped magnet slot group 105, and may contain an air layer, magnet or high magnetic resistance material.

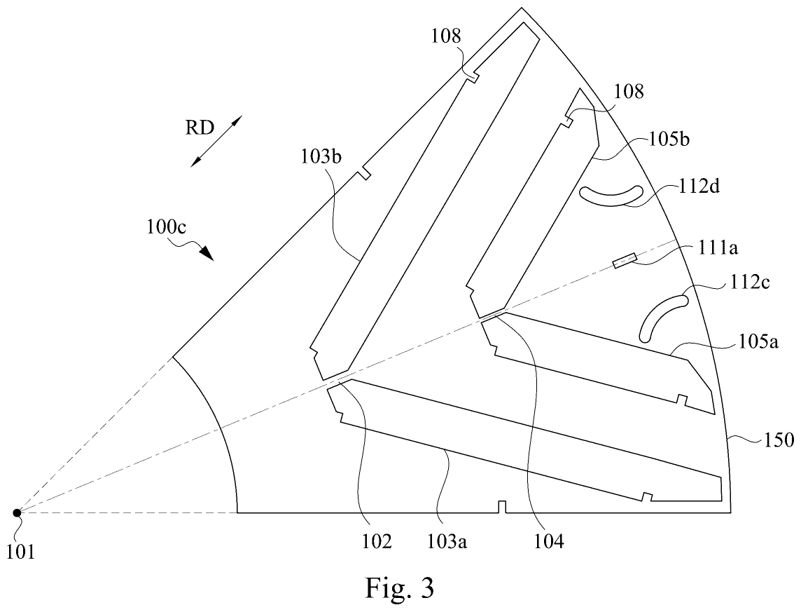

Reference is made to FIG. 3, which illustrates a top view of a single magnetic pole of a rotor structure according to a third embodiment of the present disclosure. The single magnetic pole 100c of the rotor structure also has an inner V-shaped magnet slot group 103 near the axis 101 and an outer V-shaped magnet slot group 105 near the outer edge 150 to form a double-layer V-shaped magnet slot structure. The magnetic pole 100c also has the above-mentioned technical features such as the inner magnetic bridge 102, the outer magnetic bridge 104 and the blocking point 108 similar to the magnetic pole 100a. In some embodiments of the present disclosure, the magnetic pole 100c has a rivet point 111a penetrating the silicon steel main body along the axial direction, and a connection line between the geometric center of the rivet point 111a and the axis 101 passes through the inner magnetic bridge 102 and the outer magnetic bridge 104. In some embodiments of the present disclosure, the magnetic pole 100c is different from other embodiments in that it has the arc-shaped magnetic barrier structure (112c, 112d), which is configured between the outer V-shaped magnet slot group 105 and the outer edge 150. A curvature center of the arc-shaped magnetic barrier structure (112c, 112d) generally faces towards the outer V-shaped magnet slot group 105, and may include an air layer, a magnet, or a high magnetic resistance material.

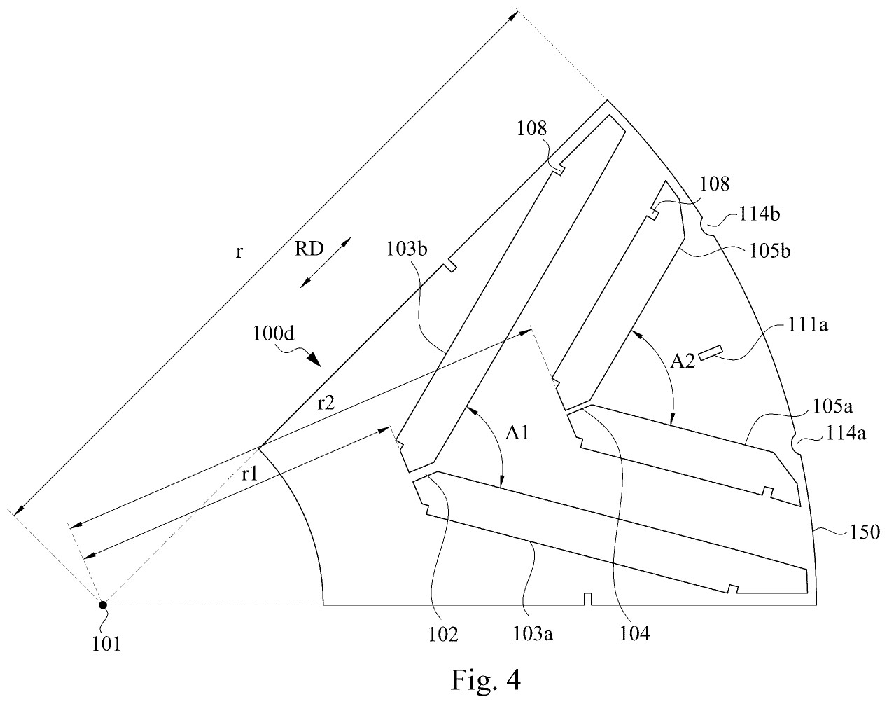

Reference is made to FIG. 4, which illustrates a top view of a single magnetic pole 100d of a rotor structure according to a fourth embodiment of the present disclosure. The single magnetic pole 100d of the rotor structure also has an inner V-shaped magnet slot group 103 near the axis 101 and an outer V-shaped magnet slot group 105 near the outer edge 150 to form a double-layer V-shaped magnet slot structure. The inner V-shaped magnet slot group 103 includes a magnet slot 103a and a magnet slot 103b, and there is an included angle A1 between the magnet slot 103a and the magnet slot 103b. The outer V-shaped magnet slot group 105 includes a magnet slot 105a and a magnet slot 105b, and there is an included angle A2 between the magnet slot 105a and the magnet slot 105b. The included angle A1 is smaller than the included angle A2. The included angle relationship of this double-layer V-shaped magnet slot structure is also applicable to other embodiments of the present disclosure. The magnetic pole 100d also has the above-mentioned technical features such as the inner magnetic bridge 102, the outer magnetic bridge 104, and the blocking point 108. In some embodiments of the present disclosure, the magnetic pole 100d has a rivet point 111a penetrating the silicon steel main body along the axial direction, and a connection line between the geometric center of the rivet point 111a and the axis 101 passes through the inner magnetic bridge 102 and the outer magnetic bridge 104 (see FIG. 3).

In some embodiments of the present disclosure, the included angle A1 of the inner V-shaped magnet slot group has the relational expression of 360/p≤A1≤r/(r−r1)×360/p, where p is quantity of the rotor magnetic pole, r is a radius of the rotor, r1 is a distance between the inner magnetic bridge 102 and the axis 101. In some embodiments of the present disclosure, the included angle A2 of the outer V-shaped magnet slot group has the relationship formula of 360/p≤A2≤r/(r−r2)×360/p, where p is quantity of rotor magnetic poles, r is a radius of the rotor, and r2 is a distance between the outer magnetic bridge 104 and the axis 101. A rotor that conforms to the above relationship of the included angles of the inner and outer magnets can achieve better torque performance. The above-mentioned angle relationship between the inner and outer V-shaped magnet slot groups is also applicable to other embodiments of the present disclosure.

In some embodiments of the present disclosure, the magnetic pole 100d is different from other embodiments in that a magnetic barrier structure (114a, 114b) with a semicircular notch is directly formed on the outer edge 150, which is configured close to the outer V-shaped magnet slot group 105, and the semicircular notches of the magnetic barrier structure (114a, 114b) are formed along the radial direction RD toward the periphery of the outer edge 150, and may contain air layers, magnets or high magnetic resistance materials.

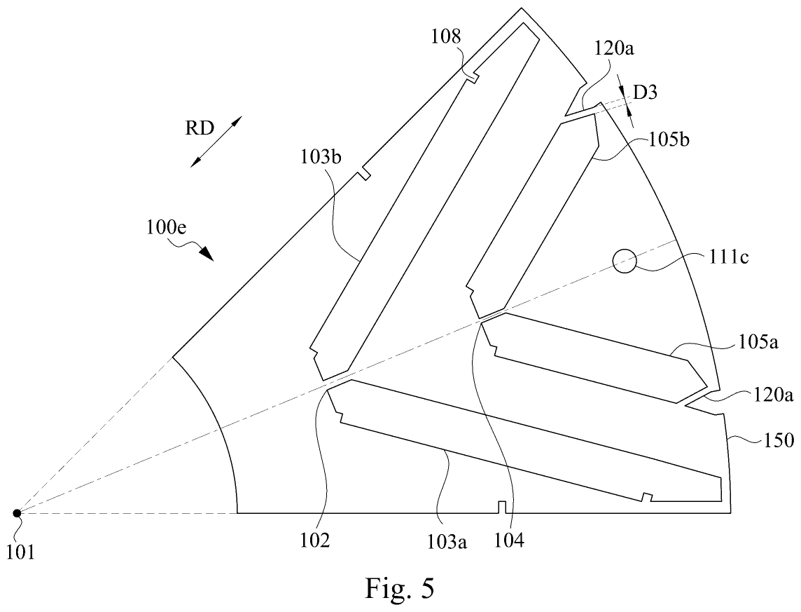

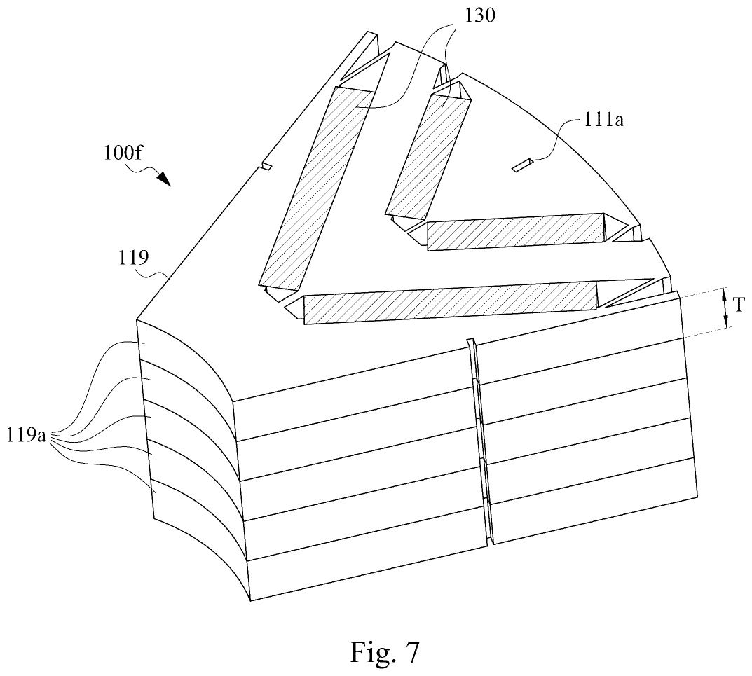

Reference is made to FIG. 5, which illustrates a top view of a single magnetic pole of a rotor structure according to a fifth embodiment of the present disclosure. The single magnetic pole 100e of the rotor structure also has an inner V-shaped magnet slot group 103 near the axis 101 and an outer V-shaped magnet slot group 105 near the outer edge 150 to form a double-layer V-shaped magnet slot structure. The magnetic pole 100e also has the above-mentioned technical features such as the inner magnetic bridge 102, the outer magnetic bridge 104, and the blocking point 108. The magnetic pole 100e has a rivet point 111c penetrating the silicon steel main body along the axial direction, and a connection line between the geometric center of the rivet point 111c and the axis 101 passes through the inner magnetic bridge 102 and the outer magnetic bridge 104. In some embodiments of the present disclosure, the magnetic pole 100e is different from other embodiments in that a circular rivet points 111c is used instead of the aforementioned rectangular rivet points, and the outer V-shaped magnet slot group 105 has a pair of radial magnetic bridges 120a. The radial magnetic bridge 120a is farther from the axis 101 than the inner magnetic bridge 102 or the outer magnetic bridge 104, and the radial magnetic bridge 120a is closer to the outer edge 150 than the inner magnetic bridge 102 or the outer magnetic bridge 104. In some embodiments of the present disclosure, the radial magnetic bridge 120a has a width D3, the width D3 is greater than the air gap width G between the rotor structure and the stator structure (referring to FIG. 1), and the width D3 is less than a thickness T of a single silicon steel sheet (referring to FIG. 7). In some embodiments of the present disclosure, rectangular or circular rivet points can be applied to various magnetic poles of the present disclosure. In some embodiments of the present disclosure, the radial magnetic bridge 120a enables the rotor structure to have better structural stress intensity and lower magnetic leakage characteristics. In some embodiments of the present disclosure, a no-load back electromotive force of a rotor structure with the radial magnetic bridge 120a (such as the embodiment in FIG. 5) is increased by about 5% compared with a rotor structure without a radial magnetic bridge (such as the embodiment in FIG. 4).

Reference is made to FIGS. 6 and 7, FIG. 6 illustrates a top view of a single magnetic pole 100f of a rotor structure according to a sixth embodiment of the present disclosure, and FIG. 7 illustrates a perspective view of the single magnetic pole 100f of the rotor structure in FIG. 6. A silicon steel main body 119 of the single magnetic pole 100f is composed of a plurality of silicon steel sheets 119a stacked in the axial direction. The magnetic poles (e.g., 100a, 100b, 100c, 100d, 100e) in the other embodiments are also composed of a plurality of stacked silicon steel sheets. The single magnetic pole 100f of the rotor structure also has an inner V-shaped magnet slot group 103 near the axis 101 and an outer V-shaped magnet slot group 105 near the outer edge 150 to form a double-layer V-shaped magnet slot structure. The magnetic pole 100f also has the above-mentioned technical features such as the inner magnetic bridge 102, the outer magnetic bridge 104, and the blocking point 108. In some embodiments of the present disclosure, the magnetic pole 100f has a rivet point 111a penetrating the silicon steel main body 119 along the axial direction, and a connection line between the geometric center of the rivet point 111a and the axis 101 passes through the inner magnetic bridge 102 and the outer magnetic bridge 104. In some embodiments of the present disclosure, the magnetic pole 100f is different from other embodiments in that both the inner V-shaped magnet slot group and the outer V-shaped magnet slot group have radial magnetic bridges (120a, 120b). The radial magnetic bridges (120a, 120b) are farther away from the axis 101 than the inner magnetic bridge 102 or the outer magnetic bridge 104, or the radial magnetic bridges (120a, 120b) are closer to the outer edge 150 than the inner magnetic bridge 102 or the outer magnetic bridge 104. In some embodiments of the present disclosure, the radial magnetic bridge 120a has a width D3 (referring to FIG. 5), the width D3 is greater than the air gap width G between the rotor structure and the stator structure (referring to FIG. 1), and the width D3 is less than the thickness T of a single silicon steel sheet 119a (referring to FIG. 7). In some embodiments of the present disclosure, the radial magnetic bridge 120b has a width D4 (referring to FIG. 6), the width D4 is greater than the air gap width G between the rotor structure and the stator structure (referring to FIG. 1), and the width D4 is less than the thickness T of a single silicon steel sheet 119a (referring to FIG. 7). In some embodiments of the present disclosure, the radial magnetic bridges (120a, 120b) enable the rotor structure to have better structural stress intensity and lower magnetic leakage characteristics. In some embodiments of the present disclosure, a no-load back electromotive force of the rotor structure with radial magnetic bridges (120a, 120b) (such as the embodiments in FIGS. 6 and 7) is increased by about 7.5% compared with the rotor structure without radial magnetic bridges (such as the embodiment in FIG. 4).

In sum, the rotor structure disclosed herein optimizes the designs of the magnetic bridge and adjusts the magnetic bridge in radial extension. The radial magnetic bridge is designed in the same direction as the centrifugal force of the rotor structure's rotating state, which can reduce stress, increase the maximum rotational speed, and effectively reduce the problem of magnetic flux leakage. In addition, a magnetic barrier structure can also be added to the outer edge of the rotor structure to increase the magnetic resistance of the silicon steel sheet path and reduce the performance degradation caused by magnetic flux leakage.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A rotor structure comprising:
a silicon steel main body has a plurality sets of magnetic poles, an axis and an outer edge, each set of magnetic pole has a double-layer V-shaped magnet slot structure;
wherein the double-layer V-shaped magnet slot structure includes an inner V-shaped magnet slot group near the axis and an outer V-shaped magnet slot group near the outer edge, the inner V-shaped magnet slot group has a first included angle between a pair of inner magnet slots, the outer V-shaped magnet slot group has a second included angle between a pair of outer magnet slots, the first included angle is smaller than the second included angle;
wherein the inner V-shaped magnet slot group has an inner magnetic bridge close to the axis along a radial direction, and the outer V-shaped magnet slot group has an outer magnetic bridge close to the axis along the radial direction, a width of the inner magnetic bridge is greater than a width of the outer magnetic bridge;
wherein any pair of the pair of inner magnet slots and the pair of outer magnet slots has two long edges, and the one of the two long edges that is relatively far away from the corresponding inner magnetic bridge or the corresponding outer magnetic bridge has a blocking point;
wherein the silicon steel main body has a rivet point, and a connection line between a geometric center of the rivet point and the axis passes through the inner magnetic bridge and the outer magnetic bridge; and
wherein the inner V-shaped magnet slot group or the outer V-shaped magnet slot group has a pair of radial magnetic bridges extending from the pair of inner magnet slots or the pair of outer magnet slots respectively, and the pair of radial magnetic bridges are farther from the axis than the inner magnetic bridge or the outer magnetic bridge.

2. The rotor structure of claim 1, wherein the width of the inner magnetic bridge is 1.5 times an air gap width between the rotor structure and a stator structure.

3. The rotor structure of claim 1, wherein the width of the outer magnetic bridge is equal to an air gap width between the rotor structure and a stator structure.

4. The rotor structure of claim 1, wherein the pair of radial magnetic bridges have a width greater than an air gap width between the rotor structure and a stator structure.

5. The rotor structure of claim 4, wherein the silicon steel main body comprises a plurality of silicon steel sheets stacked along an axial direction, and the width of the pair of radial magnetic bridges is smaller than a thickness of a single one of the silicon steel sheets.

6. The rotor structure of claim 1, further comprising a plurality of magnets disposed in the pair of inner magnet slots and the pair of outer magnet slots, each of the magnets has a width W, and the blocking point has a height h, wherein W/10≤h≤W/5.

7. The rotor structure of claim 1, wherein the rivet point has a rectangular shape or a circular shape.

8. The rotor structure of claim 1, wherein the silicon steel main body further includes a plurality of magnetic barrier structures disposed close to where between the outer edge and the pair of outer magnet slots.

9. The rotor structure of claim 8, wherein each magnetic barrier structure is selected from the group consisting of a rectangular magnetic barrier with a long axis direction perpendicular to the outer V-shaped magnet slot group, a rectangular magnetic barrier with a long axis direction perpendicular to the outer edge, an arc-shaped magnetic barrier with a curvature center facing the outer V-shaped magnet slot group, and a semicircular notch magnetic barrier formed along the radial direction toward a periphery of the outer edge.

10. The rotor structure of claim 1, wherein a ratio of the width of the inner magnetic bridge to the width of the outer magnetic bridge ranges from 1.2 to 1.6.

11. A rotor structure comprising:
a silicon steel main body has a plurality sets of magnetic poles, an axis and an outer edge, each set of magnetic pole has a double-layer V-shaped magnet slot structure;
wherein the double-layer V-shaped magnet slot structure includes an inner V-shaped magnet slot group near the axis has a pair of inner magnet slots and an outer V-shaped magnet slot group near the outer edge has a pair of outer magnet slots;
wherein the inner V-shaped magnet slot group has an inner magnetic bridge close to the axis along a radial direction, and the outer V-shaped magnet slot group has an outer magnetic bridge close to the axis along the radial direction, a width of the inner magnetic bridge is greater than a width of the outer magnetic bridge;
wherein any pair of the pair of inner magnet slots and the pair of outer magnet slots has two long edges, and the one of the two long edges that is relatively far away from the corresponding inner magnetic bridge or the corresponding outer magnetic bridge has a blocking point; and
wherein the inner V-shaped magnet slot group or the outer V-shaped magnet slot group has a pair of radial magnetic bridges extending from the pair of inner magnet slots or the pair of outer magnet slots respectively, and the pair of radial magnetic bridges are farther from the axis than the inner magnetic bridge or the outer magnetic bridge.

12. The rotor structure of claim 11, wherein the width of the inner magnetic bridge is 1.5 times an air gap width between the rotor structure and a stator structure.

13. The rotor structure of claim 11, wherein the width of the outer magnetic bridge is equal to an air gap width between the rotor structure and a stator structure.

14. The rotor structure of claim 11, wherein the pair of radial magnetic bridges have a width greater than an air gap width between the rotor structure and a stator structure.

15. The rotor structure of claim 11, further comprising a plurality of magnets disposed in the pair of inner magnet slots and the pair of outer magnet slots, each of the magnets has a width W, and the blocking point has a height h, wherein W/10≤h≤W/5.
